(19) United States
(12) Patent Application Publication
(10) Pub. No.: US 2018/0056842 A1
(43) Pub. Date: Mar. 1, 2018

(54) TAILGATE ASSEMBLY WITH INTEGRAL RAMP SYSTEM

(71) Applicant: FORD GLOBAL TECHNOLOGIES, LLC, Dearborn, MI (US)

(72) Inventor: Jorge Adolfo Miranda Nieto, Leon (MX)

(21) Appl. No.: 15/250,971

(22) Filed: Aug. 30, 2016

(51) Int. Cl. B60P 1/43; B62D 33/027

(52) U.S. Cl. CPC B60P 1/435; B62D 33/0273

(57) ABSTRACT

A tailgate assembly includes a tailgate body and a ramp. The tailgate body has an internal cavity and the ramp is displaceable between a stowed position in the internal cavity and a deployed position extending laterally from the tailgate body. A related method is also disclosed.

### TECHNICAL FIELD

This document relates generally to the motor vehicle equipment field and, more particularly, to a tailgate assembly for a pickup truck or the like that incorporates an integral ramp system. Such a ramp system is adapted to provide improved access to the load bed of the pickup truck.

### BACKGROUND

It is known in the art to integrate a ramp system into the tailgate of a pickup truck or like vehicle. Examples of such ramp systems are disclosed in, for example, U.S. Pat. No. 5,312,149 and published U.S. Patent Application 2013/0019417.

Significantly, ramp systems that are deployed from a tailgate along the longitudinal or X axis of the pickup truck are deployed along the short dimension axis of the tailgate and must provide a way to expand the length of the ramp in order to provide a ramp that spans to the ground with an incline at a functional angle. Thus, in U.S. Pat. No. 5,312,149, the ramp includes a relatively complicated and expensive telescoping structure while in published U.S. Patent Application 2013/0019417, the ramp includes a relatively complicated and expensive expandable lattice structure.

This document relates to a new and improved tailgate assembly incorporating an integrated ramp system that is deployed so as to extend laterally from the tailgate body: that is along the longitudinal axis of the tailgate. Thus, the ramp may be made longer so that when the ramp is extended to span to the ground, the ramp is inclined at a functional angle. Advantageously, this is accomplished using a single piece ramp without any complicated structures for extending or expanding the length of the ramp.

### SUMMARY

In accordance with the purposes and benefits described herein, a tailgate assembly is provided. That tailgate assembly comprises a tailgate body including an internal cavity and a ramp that is displaceable between a stowed position in that cavity and a deployed position extending laterally from the tailgate body.

The tailgate body may include a lateral axis extending from a first sidewall to a second sidewall. Further, the first sidewall may include an access opening in communication with the internal cavity. In addition, the first sidewall may include a scallop. Further, the ramp may include a handhold that is aligned with the scallop when the ramp is in the stowed position.

The tailgate assembly may further include a guide track within the internal cavity. Still further, the ramp may include a first set of opposed guide wheels that ride in that guide track. Further, the ramp may include a second set of opposed guide wheels that also ride in that guide track. In at least some of many possible embodiments, that guide track may include first and second guide rails.

Still further, the ramp may include a stop. Further, the handhold may be provided at a first end of the ramp while the stop is provided at a second, opposite end of the ramp. Further, the tailgate body may include a bumper. The stop engages the bumper when the ramp is in the fully deployed position thereby preventing the ramp from being inadvertently pulled completely out of the tailgate body.

In accordance with an additional aspect, a pickup truck is provided including the tailgate assembly being described in this document. Further, a method is also provided. That method relates to the providing of ramp access to a load bed of a pickup truck. More specifically, the method includes the step of deploying a ramp from within an internal cavity of a tailgate body of the pickup truck so that the ramp extends laterally from the tailgate body. Thus, the ramp extends parallel with the lateral or Y axis of the pickup truck as per the SAE vehicle axis system.

In the following description, there are shown and described several preferred embodiments of the tailgate assembly. As it should be realized, the tailgate assembly is capable of other, different embodiments and its several details are capable of modification in various, obvious aspects all without departing from the tailgate assembly as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the tailgate assembly and together with the description serve to explain certain principles thereof. In the drawing figures:

FIG. 1 is a rear perspective view of the rear portion of a pickup truck illustrating the tailgate assembly in an open position and the integral ramp of the tailgate assembly held in a stowed position within a cavity of the tailgate body.

FIG. 2 is a detailed cross-sectional of the tailgate body illustrating a scallop in the first sidewall of the tailgate body that allows one to easily access a handhold provided at the first end of the ramp.

FIG. 3 is a schematic cross-sectional view of the tailgate assembly illustrating the ramp in the stowed position with the opposed guide wheels of the ramp riding in opposed first and second guide rails of a guide track fixed to the tailgate body.

FIGS. 4a-4c illustrate how the ramp is deployed from the tailgate body. FIG. 4a illustrates the ramp as it is initially being displaced from the stowed position to the deployed position. FIG. 4b illustrates the ramp when it has been completely extended from the tailgate body. FIG. 4c illustrates the ramp in the fully deployed position with the stop provided on the second end of the ramp engaging the bumper fixed to the tailgate body so as to hold the second end of the ramp in the internal cavity of the tailgate body and thereby secure the upper end of the ramp when the ramp is in the inclined position.

Reference will now be made in detail to one possible embodiment of the tailgate assembly as illustrated in the accompanying drawing figures.

### DETAILED DESCRIPTION

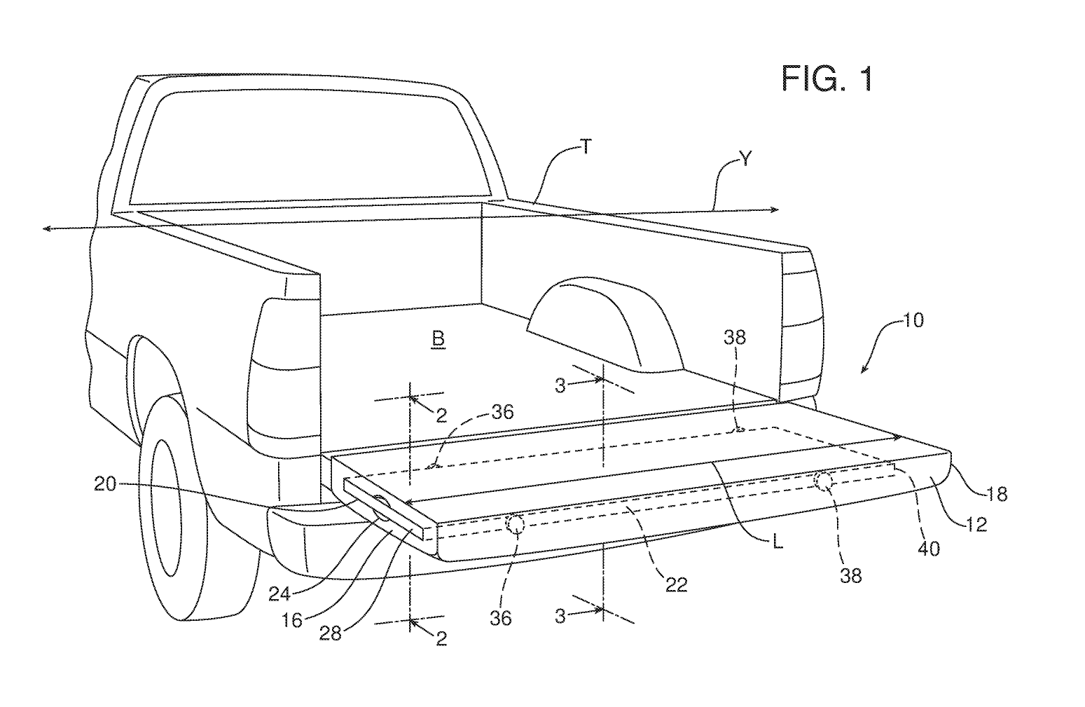

Reference is now made to FIGS. 1-4c illustrating the tailgate assembly 10. The tailgate assembly 10 includes a tailgate body 12 having an internal cavity 14.

As illustrated, the tailgate body 12 includes a lateral axis L which extends from a first sidewall 16 to a second sidewall 18. An access opening 20 is provided in the first sidewall 16. That access opening 20 is in communication with the internal cavity 14.

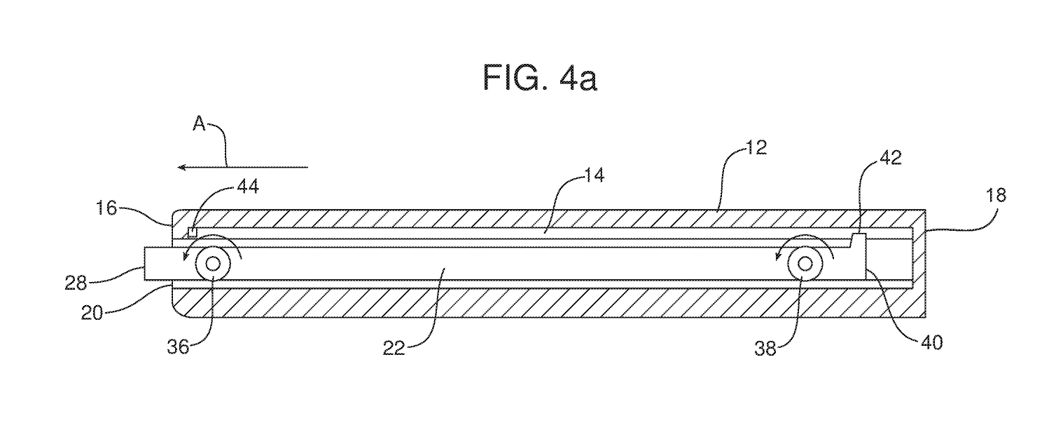

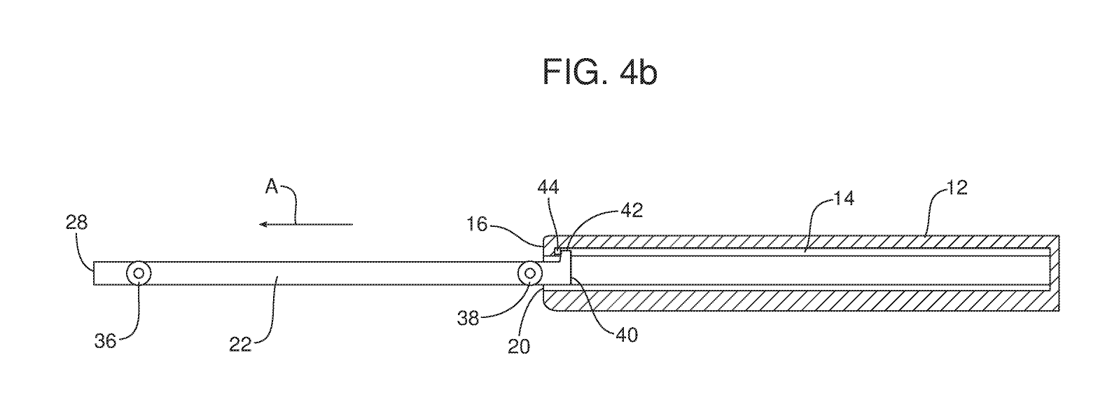

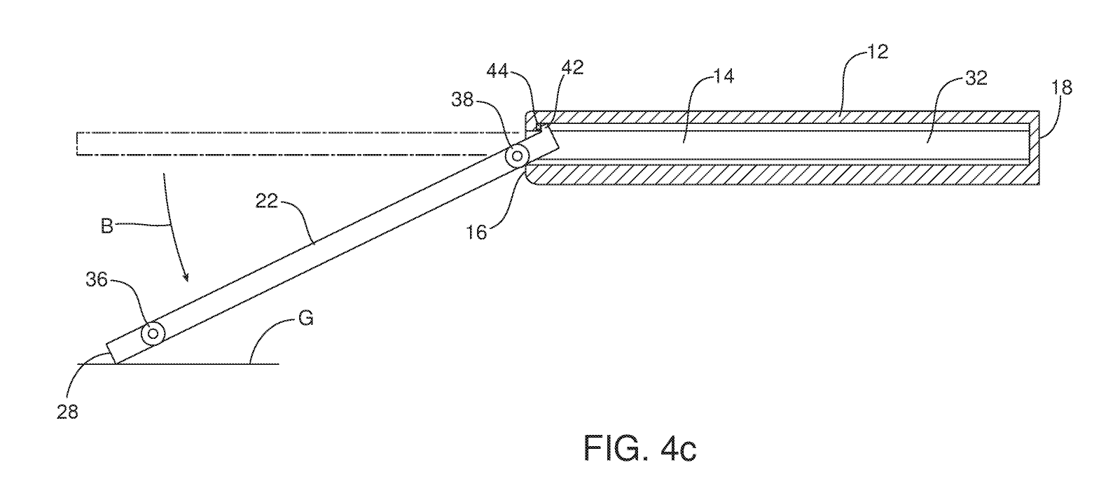

As further illustrated, the tailgate assembly 10 includes a ramp 22. The ramp 22 is displaceable between a stowed position wherein the ramp is held within the internal cavity (see FIG. 1) and a deployed position wherein the ramp extends laterally from the tailgate body 12 (see FIG. 4c).

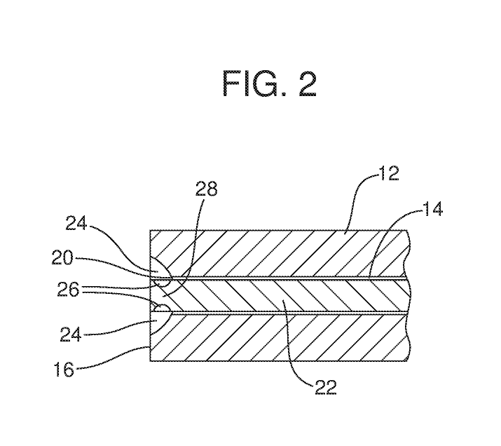

As best illustrated in FIGS. 1 and 2, the first sidewall 16 of the tailgate body 12 includes a scallop 24: that is, a curved notch. The ramp 22 includes a handhold 26 at a first end 28 of the ramp. The handhold 26 is aligned with the scallop 24 when the ramp 22 is in the stowed position. This allows an operator to easily access and engage the handhold 26 in order to displace the ramp from the stowed position to the fully deployed position illustrated in FIG. 4c.

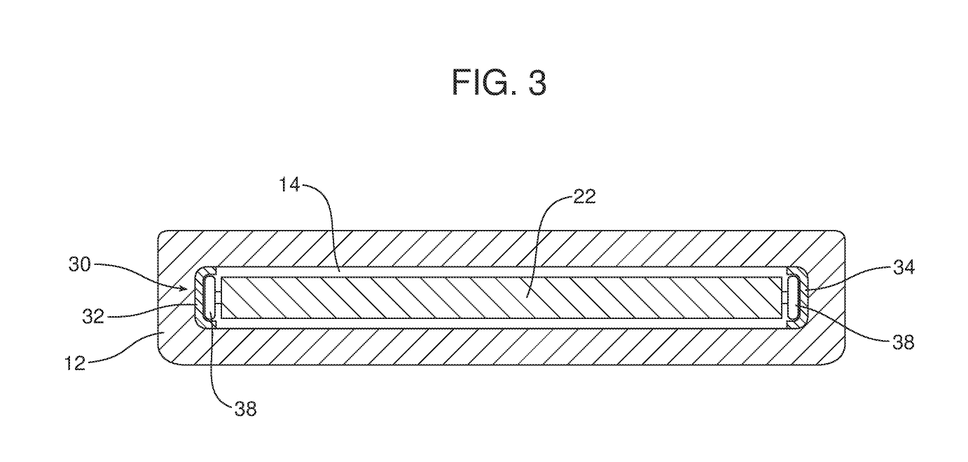

A slide mechanism allows an operator to conveniently displace the ramp 22 between the stowed and deployed positions. As best illustrated in FIG. 3, that slide mechanism includes a guide track 30 consisting of a first guide rail 32 and a second guide rail 34. In the illustrated embodiment the first guide rail 32 and the second guide rail 34 comprised opposed, C-shaped rails that are held within the internal cavity 14 and fixed to the tailgate body 12.

The ramp 22 includes a first set of opposed guide wheels 36 adjacent the first end 28 of the ramp and a second set of opposed guide wheels 38 adjacent a second end 40 of the ramp. The two sets of opposed guide wheels 36, 38 are received within and ride along the opposed first and second guide rails 32, 34 of the guide track 30 as the ramp 22 is displaced between the stowed and deployed positions.

Reference is now made to FIGS. 4a-4c illustrating how the ramp 22 is displaced from the stowed position illustrated in FIG. 1 to the fully deployed position illustrated in FIG. 4c. In order to deploy the ramp 22, one first engages the handhold 26 at the first end 28 of the ramp 22. That handhold 26 is easily accessed through the scallop 24 in the first sidewall 16 of the tailgate body 12 (see FIG. 2).

One then begins to pull the ramp 22 laterally (see action arrow A in FIG. 4a) so that the ramp is gradually extended from the internal cavity 14 in the tailgate body 12 through the access opening 20 in the first sidewall 16 of the tailgate body. As should be appreciated, the first and second sets of opposed guide wheels 36, 38 roll freely along the opposed first and second guide rails 32, 34 of the guide track 30 so that the ramp 22 may be deployed in a smooth and efficient manner. When the ramp 22 is fully extended from the tailgate body 12, a stop 42 at the second end 40 of the ramp engages with a bumper 44 fixed to the tailgate body 12 thereby preventing one from inadvertently pulling the ramp completely out of the tailgate body.

Once the ramp 22 has been fully extended from the tailgate body as illustrated in FIG. 4b, one pivots the ramp 22 downwardly in the direction of action arrow B until the first end 28 of the ramp engages the ground G as illustrated in FIG. 4c. As clearly shown in FIG. 4c, the stop 42 at the second end 40 of the ramp 22 remains in engagement with the bumper 44 thereby securing the second or upper end of the ramp within the internal cavity 14 of the tailgate body. When in the fully deployed position illustrated in FIG. 4c, the ramp 22 has a sufficient length to provide an incline at a functional angle of between, for example, about 28 and 40 degrees with respect to the ground (that is: one that is not too steep and reasonable to climb).

Consistent with the above description, a method of providing ramp access to a load bed B of a pickup truck T is provided (see FIG. 1). That method includes the step of deploying the ramp 22 from within the internal cavity 14 of the tailgate body 12. This is done so that the ramp 22 extends laterally from the tailgate body 12. Thus, the ramp 22 extends parallel with the lateral or Y axis of the pickup truck T as per the SAE vehicle axis system.

One may easily return the ramp 22 to the stowed position by reversing the steps illustrated in FIGS. 4a-4c. Thus, one first pivots the ramp upwardly from the fully deployed position illustrated in FIG. 4c into the fully extended horizontal position illustrated in FIG. 4b. Next, one pushes the ramp 22 into the internal cavity 14 in the tailgate body 12 through the access opening 20 in the first sidewall 16 of the tailgate body until the ramp 22 is in the stowed position illustrated in FIG. 1. While not shown, it should be appreciated that a lock of substantially any appropriate type may be engaged in order to secure the ramp 22 in the stowed position and thereby allow the tailgate assembly 10 to be closed.

The foregoing has been presented for purposes of illustration and description. It is not intended to be exhaustive or to limit the embodiments to the precise form disclosed. Obvious modifications and variations are possible in light of the above teachings. For example, the guide track 30 does not necessarily need to include first and second C-shaped guide rails 32, 34 nor do the first and second set of guide wheels 36, 38 necessarily need to be opposed. Further, fewer or more sets of opposed guide wheels may be provided.

In the illustrated embodiment, the guide track 30 is fixed to the tailgate body 12 while the first and second sets of opposed guide wheels 36, 38 are rotatably mounted and carried on the ramp 22. In some embodiments, the sets of guide wheels 36, 38 may be rotatably mounted to the tailgate body 12 while the guide track 30 is mounted on the ramp 22.

All such modifications and variations are within the scope of the appended claims when interpreted in accordance with the breadth to which they are fairly, legally and equitably entitled.

1. A tailgate assembly, comprising:
a tailgate body including an internal cavity;
a single-piece ramp displaceable between a stowed position in said internal cavity and a deployed position extending laterally from said tailgate body; and
a guide track and a first set of guide wheels for sliding said ramp with respect to said tailgate body when said ramp is displaced between said stowed position and said deployed position.

2. The tailgate assembly of claim 1, wherein said tailgate body includes a lateral axis extending from a first sidewall to a second sidewall.

3. The tailgate assembly of claim 2, wherein said first sidewall includes an access opening in communication with said internal cavity.

4. The tailgate assembly of claim 3, wherein said first sidewall includes a scallop.

5. The tailgate assembly of claim 4, wherein said ramp includes a handhold aligned with said scallop when said ramp is in said stowed position.

6. The tailgate assembly of claim 3, wherein said guide track is positioned within said internal cavity.

7. The tailgate assembly of claim 6, wherein said ramp includes the first set of opposed guide wheels riding in said guide track.

8. The tailgate assembly of claim 7, wherein said ramp includes a second set of opposed guide wheels riding in said guide track.

9. The tailgate assembly of claim 8, wherein said guide track includes a first guide rail and a second guide rail.

10. The tailgate assembly of claim 9, wherein said ramp includes a stop.

11. The tailgate assembly of claim 10, wherein a handhold is at a first end of said ramp and said stop is at a second end of said ramp.

12. The tailgate assembly of claim 11, wherein said tailgate body includes a bumper, said stop engaging said bumper when said ramp is in said deployed position.

13. (canceled)

14. The tailgate assembly of claim 1, wherein said guide track includes a first guide rail and a second guide rail.

15. The tailgate assembly of claim 14, wherein said first guide rail and said second guide rail are both fixed to said tailgate body.

16. The tailgate assembly of claim 15, wherein said first set of guide wheels are rotatably attached to said ramp.

17. The tailgate assembly of claim 16, further including a second set of guide wheels rotatably attached to said ramp.

18. A pickup truck including said tailgate assembly of claim 16.

19. A pickup truck including said tailgate assembly of claim 1.

20. A method of providing ramp access to a load bed of a pickup truck, comprising:
providing a one-piece ramp having at least one set of opposed guide wheels; and
deploying the ramp from within an internal cavity of a tailgate body of said pickup truck so that said ramp extends laterally from said tailgate body.
